(19) United States
(12) Patent Application Publication
(10) Pub. No.: US 2019/0034481 A1
(43) Pub. Date: Jan. 31, 2019

(54) DATA STORES FOR GENERATING AN INFORMATION SOURCE

(71) Applicant: NewsRx, LLC, Atlanta, GA (US)

(72) Inventors: Charles W. Henderson, Atlanta, GA (US); Alan D. Henderson, Watkinsville, GA (US); Chantay P. Jones, Marietta, GA (US); Kalani K. Rosell, New Haven, CT (US)

(21) Appl. No.: 15/663,327

(22) Filed: Jul. 28, 2017

(51) Int. Cl. G06F 17/30

(52) U.S. Cl. CPC G06F 17/30392; G06F 17/30395; G06F 17/30398; G06F 17/3061; G06F 17/30592; G06F 17/30595; G06F 17/30705; G06F 17/30421

(57) ABSTRACT

Technologies are described herein for generating an information source, such as a newsletter. Sources of information are retrieved, analyzed, and, as a result of the analysis, search articles are generated. The search articles are generated in a manner that is more suited to the search and retrieval of information to form information sources. Filters applicable to the search articles are generated when the search articles are generated. The filters are used to organize the search articles, generate and organize chapters, generate a table of contents, and generate an index.

### BACKGROUND

Newsletters, and other types of content distribution services, use information sources to retrieve and distribute content. For example, an Internet search engine will search websites and other information sources using various algorithms and return the search results in a search Interface. In another example, a newsletter distribution system may search for information from various sources, collect and organize that information, and distribute that information in a desired newsletter format.

It is with respect to these and other considerations that the disclosure made herein is presented.

### SUMMARY

Technologies are described herein for data stores for generating an information source. Generally, a data store comprises one or more articles. The articles comprise information retrieved from a third-party source. The third-party source is analyzed and an article describing at least a portion of the information described in the third-party source is generated. During generation of the article, one or more labels (or filters) are generated. The articles and the associated filters are stored. To generate an information source, such as a newsletter, the data store having the article stored therein is searched and relevant articles are retrieved based on the filters and search terms. The articles are organized and outputted as the information source, such as a newsletter.

It should be appreciated that the above-described subject matter can be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating a newsletter generation system.

FIG. 2 is a screen diagram showing an illustrative newsletter generator user interface.

FIG. 3 is a screen diagram showing an illustrative newsletter generator user interface for modifying chapters of the search articles.

FIG. 4 is a screen diagram showing an illustrative chapter modification interface 402.

FIG. 5 is a screen diagram showing an illustrative newsletter builder interface.

FIG. 6 is an illustrative table of contents.

FIG. 7 is an illustrative index.

FIG. 8 is a flow diagram showing aspects of a method disclosed herein for generating a newsletter.

FIG. 9 is a computer architecture diagram illustrating an illustrative computer hardware and software architecture for a computing system capable of implementing the technologies presented herein.

### DETAILED DESCRIPTION

The following detailed description is directed to technologies for data stores to generate informational sources. In conventional systems, sources of information are typically indifferent to the searches performed on them and for the generation of informational sources. For example, an Internet search engine analyzes web pages and outputs links to the webpages the search engine determines are most relevant. However, the information displayed or stored for a web page is not changed based on searches.

In some conventional systems, web pages (and other sources of information) can have items called “keywords” associated with the web page. In some examples, a keyword is a word or phrase that describes an aspect (such as part of the content) of the information source. For example, a news article about a car accident can have keywords such as “car” and “accident” associated with the news article. When performing searches, algorithms can be applied that, upon finding the keywords, can return the article as a search result. In summary, keywords are generated based on the content of the article.

In a distinctly different manner, the presently disclosed subject matter describes a data store structure whereby filters are generated based on a use of an informational source. In some examples, an information source generator searches for informational sources relating to an information source to be generated. For example, the information source to be generated can be a newsletter relating to cancer research. The search engine will search and find articles, documents, web pages, and other sources of information (referred to herein generally as an “article”) relating to cancer research.

Upon finding an article relating to the research, various examples of the presently disclosed subject matter analyze the article (e.g. the “source article”) and generate a “search article” from the source article. The search article is a modified form of the article in which information from the source article broken down, filtered, and reorganized in the search article. For example, an article about cancer research may include various other items of information not directed related or determined to be pertinent to the research itself. The bios of the researchers, opinions, and the like, though helpful in some contexts, may not be determined to be relevant to the actual research. Further, the article may be organized in a manner that is difficult to read or requires a long time to learn the information.

Thus, a search article is generated and is purpose-built for newsletter generation. In some examples, the search article may be generated using an artificial intelligence source using an artificial intelligence journalist. As used herein, artificial intelligence refers to intelligence provided by machines or computers. As used herein, the artificial intelligence journalist is a computer or process whereby a computer applies algorithms to event information and generates the search article.

In some examples, artificial intelligence journalist may receive a source article. The artificial intelligence journalist may apply one or more filters to reduce or eliminate certain or predetermined types of information. For example, the artificial intelligence journalist may apply a filter to raw information that recognizes non-factual, opinion, colloquial, relativistic, or others types of information to create filtered information. The artificial intelligence journalist may thereafter add information to the filtered information to connect various concepts found in the filtered information to provide for enhanced information. The enhanced information may thereafter be stored as the search article.

For example, the artificial intelligence journalist may receive the following snippet of a source article:

Scientists in Belgium report that Mary has discovered a new element. Mary is from South Carolina and enjoys surfing and racquetball. Mary has named the element, Marium. We do not think that Mary is telling the truth and would like to see the final outcome when published in Scientist Daily.

As can be seen in the article above, the article includes factual information, opinion information (We do not think . . . ), and information that is not relevant (Mary is from . . . ) to the main story ( . . . discovered a new element). In some examples, the artificial intelligence journalist may apply one or more filters to create the filtered information. In one example, the artificial intelligence journalist may identify the particle event (or subject) of the article: the discovery of a new element.

The artificial intelligence journalist may then analyze the article to determine which words or sentences are most likely applicable to the event and maintain those words or sentences while filtering out or removing the words or sentences that are least likely applicable. The following may be the result of the filtering operation:

Scientists in Belgium report that Mary has discovered a new element . . . Mary has named the element, Marium . . . final outcome when published in Scientist Daily.

As can be seen in the example provided above, while condensed to information relating to the event, if read by a human, the above information may not be easy or pleasant to read. The artificial intelligence journalist may then apply information to create enhanced information, resulting in the search article.

Continuing with the example above, the search article may be the following (with additions shown underlined and subtractions shown with strikethroughs only for purposes of description).

Scientists in Belgium report that Mary has discovered a new element. Mary has named the element, Marium. [The] final outcome when will be published in Scientist Daily.

It should be noted that the presently disclosed subject matter is not limited to the above-described algorithm, and may include other technologies for generating artificial intelligence articles.

As part of the process of generating the search article, one or more filters are generated. For example, the snippet provided below:

Scientists in Belgium report that Mary has discovered a new element. Mary has named the element, Marium. [The] final outcome when will be published in Scientist Daily.

may result in the filters: Belgium, new element, Marium, Scientist Daily. The filters generated with the search article can be used to generate newsletters and other sources of information.

Various aspects of the presently disclosed subject matter offer various technical advantages. For example, because the search article is generated for a specific purpose, the filters generated can be more relevant than the original filters applied to the source article. For example, a source article can contain undesired information such as opinions.

Keywords can be generated from the undesired information, and if used, can result in articles that are not relevant or not usable for a desired purpose. Further, it is not uncommon for keywords to be generated that have little to no association with the information source, but rather, are used to increase the odds that the source article is a search result. Thus, in some examples, the generation of a source article and filters can be a more efficient means of providing information.

While the subject matter described herein is presented in the general context of program modules that execute in conjunction with the execution of an operating system and application programs on a computer system, those skilled in the art will recognize that other implementations can be performed in combination with other types of program modules. Generally, program modules include routines, programs, components, data structures, and other types of structures that perform particular tasks or implement particular abstract data types. Moreover, those skilled in the art will appreciate that the subject matter described herein can be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific examples. Referring now to the drawings, aspects of technologies for data stores for generating an information source will be presented.

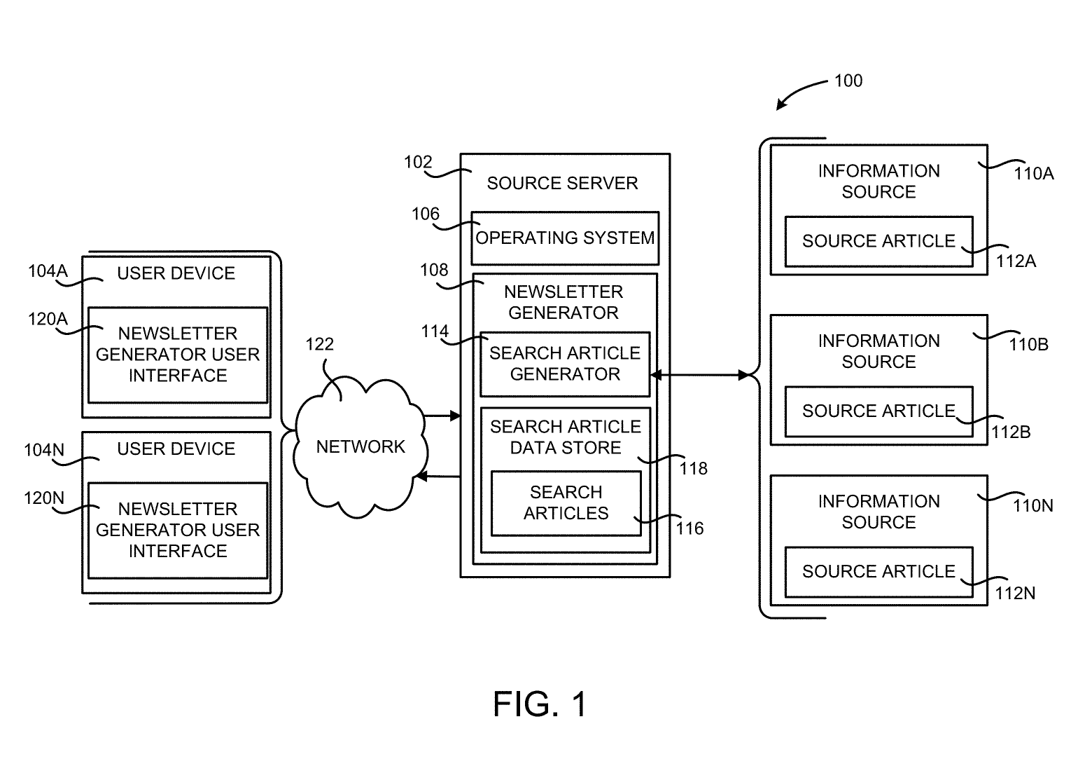

Referring now to FIG. 1, aspects of a data store system 100 for information source generation are described. The data store system 100 shown in FIG. 1 includes a source server 102 and user devices 104A-104N (hereinafter generally referred to as “user devices 104,” and individually as “user device 104A,” “user device 104N,” and the like). The source server 102 executes an operating system 106. The operating system 106 is a computer program for controlling the operation of the source server 102. The operating system 106 executes a newsletter generator 108.

The newsletter generator 108 searches information sources 110A-110N (hereinafter generally referred to as “information sources 110,” and individually as “information source 110A,” “information source 110N,” and the like). The search performed by the newsletter generator 108 is to find source articles 112A-112N (hereinafter generally referred to as “source articles 112,” and individually as “source article 112A,” “source article 112N,” and the like) stored in the information sources 110.

Once the source articles 112 are retrieved from the information sources 110, the newsletter generator 108 invokes a search article generator 114. The search article generator 114 analyzes the source articles 112 and generates one or more search articles 116 to be stored in a search article data store 118. The search articles 116 are stored with the filters generated during the search article generation phase. An example of generating a search article is provided above. The presently disclosed subject matter is not limited to any particular method of generating the search articles 116. The search articles 116 can be generated using various methods to change the source articles 112 from use-agnostic sources to use-specific sources.

During use, a user (not illustrated) can access the search articles 116 using the user devices 104A or 104N. The user devices 104 are configured to execute a newsletter generator user interfaces 120A and 102N on user devices 104A and 104N, respectively. The newsletter generator user interfaces 120A and 120N are designed to receive one or more search inputs from the user. It is to be noted that the presently disclosed subject matter is not limited to any particular type of user, as a user may be a human or a user may be a program or other entity using the newsletter generator user interfaces 120A and 102N.

For example, a user may invoke the newsletter generator user interface 120A using the user device 104A. The user may input search terms for one or more articles. The search terms are transmitted to the newsletter generator 108 through network 122. The newsletter generator 108 accesses the search article data store 118 to determine one or more articles 116 that are relevant to the search terms using the filters of the search articles 116 and the received search terms. The newsletter generator 108 thereafter compiles the articles 116 that are relevant into an output format, such as a newsletter. The newsletter is thereafter transmitted to the user device 104A.

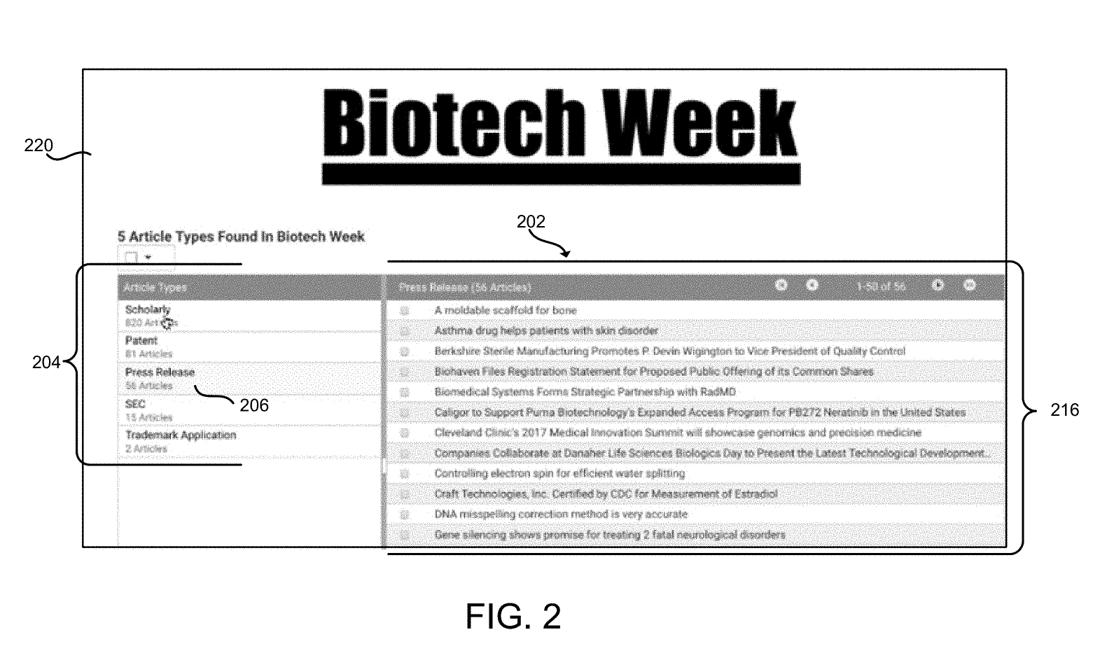

FIG. 2 is a screen diagram showing an illustrative newsletter generator user interface 220. In some examples, the newsletter generator 108 may provide a user with various capabilities to construct a newsletter in a manner desired by the user. In FIG. 2, the newsletter generator user interface 220 has rendered therein a search article list 202 of search articles 216. The search articles 216 are identified by the newsletter generator 108 as being relevant to search terms received.

To help a user organize the newsletter, the newsletter generator user interface 220 includes article type list 204. The article type list 204 is a list comprising one or more types of articles presented in the search article list 202. The article type list 204 is configured to receive an input to select or deselect various search articles 216. For example, an input can be received that the only search articles 216 to be part of the newsletter are press releases 206. The newsletter generator 108 receives the input and removes the search articles 216 that are not identified as press releases 206. The presently disclosed subject matter can be configured so that one or more types of articles can be selected for inclusion or exclusion.

In some examples, the article type list 204 are a type of filter generated during the process of generating the search articles 216. The newsletter generator 108 may determine, based on various headings or word in the source articles 112 that the type of article correlates to a particular type. For example, the source article 112B (from FIG. 1) can be a published patent application. The newsletter generator 108, when constructing the search article 116, can analyze the header of the published patent application and determine that the resulting search article 116 type is a patent application.

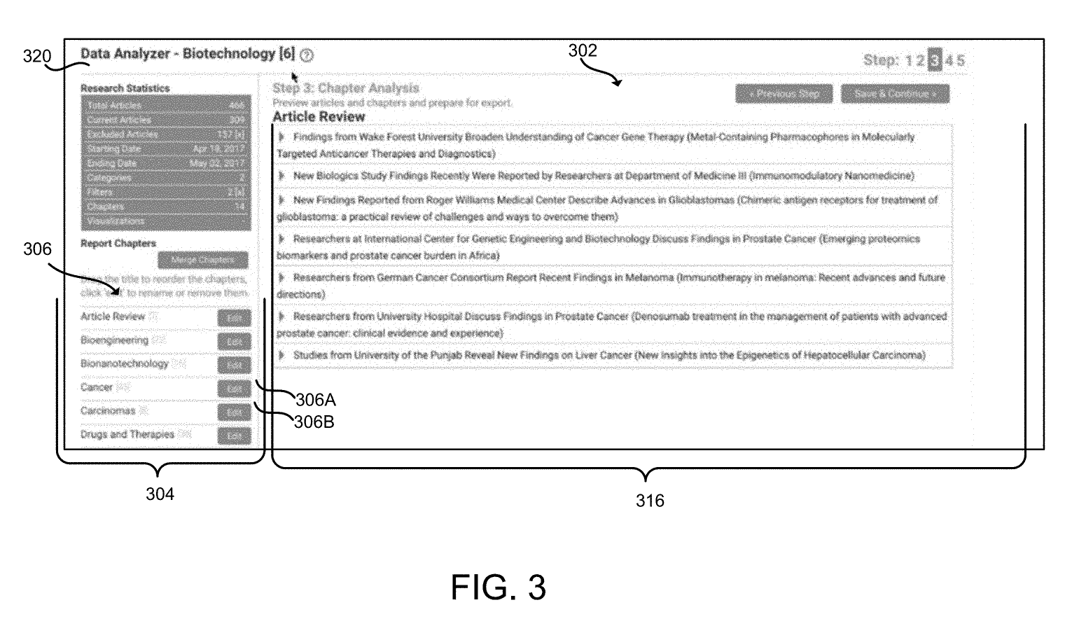

FIG. 3 is a screen diagram showing an illustrative newsletter generator user interface 320 for modifying chapters of the search articles 116. In some examples, the newsletter generator 108 may provide a user with various capabilities to construct a newsletter by modifying chapters of the newsletter. In FIG. 3, the newsletter generator user interface 320 has rendered therein a search article list 302 of search articles 316. The search articles 316 are identified by the newsletter generator 108 as being relevant to search terms received.

During the process to generate the search articles 316, one or more filters that are generated may be used as chapter determinations. In FIG. 3, chapters 306 found in chapter list 304 can be determined based on various factors, such as commonality or prevalence of filter among one or more search articles 316. The chapters 306 can be used to segregate or separate the articles 316 into different sections. For example, the chapters 304 can be used to organize the search articles 316 into sections of common subject matter and the like. For example, the filter cancer 306A can be a filter, such as a term or phrase, that is found in more than three search articles 316. In another example, the filter carcinomas 306B can be a filter found in several of the search articles 316 as well as a search term received to conduct the search for the search articles 316.

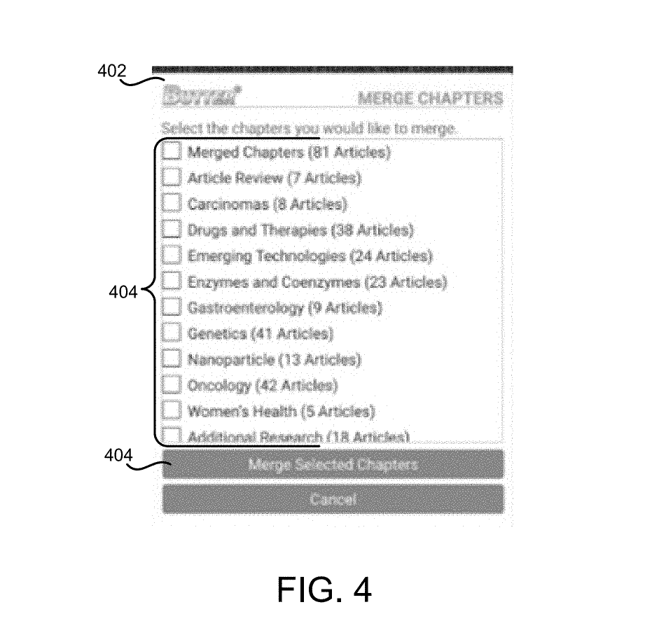

FIG. 4 is a screen diagram showing an illustrative chapter modification interface 402. In some examples of the presently disclosed subject matter, it may be desirable to modify chapters according to a desired preference of a user using the newsletter generator user interface 320 to generate a newsletter (or another type of information source). The chapter modification interface 402 is an illustrative example of how chapters 404 may be modified. The chapter modification interface 402 is configured to receive an input to merge one or more of the chapters 404. When merged, the merged chapters 404 can receive the name of one of the chapters that were merged or another name, which may be designated by a user or another entity. When merged, the articles 404 in each respective, merged chapters are combined under the merged chapter name.

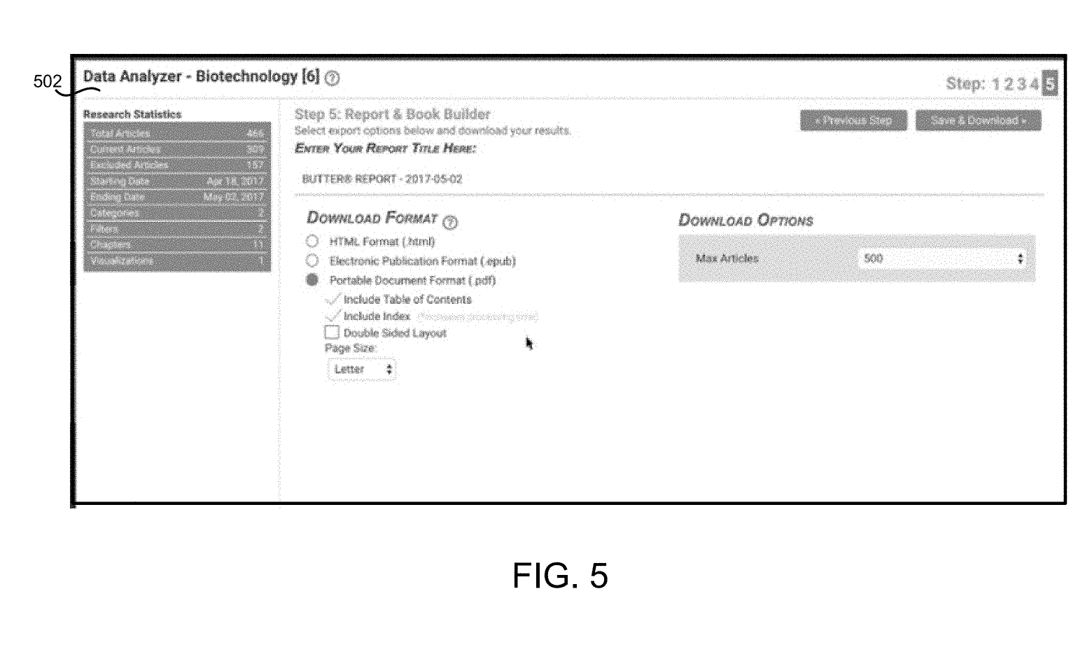

FIG. 5 is a screen diagram showing an illustrative newsletter builder interface 502. The newsletter builder interface 502 is invoked to generate an information source, such as a newsletter. The newsletter building interface 502 can receive a format input 504. The format input 504 provides input to the newsletter generator 108 of the type of file format for which to generate a newsletter. Examples of formats include, but are not limited to, HTML (HyperText Markup Language), electronic publication format, and portable document format.

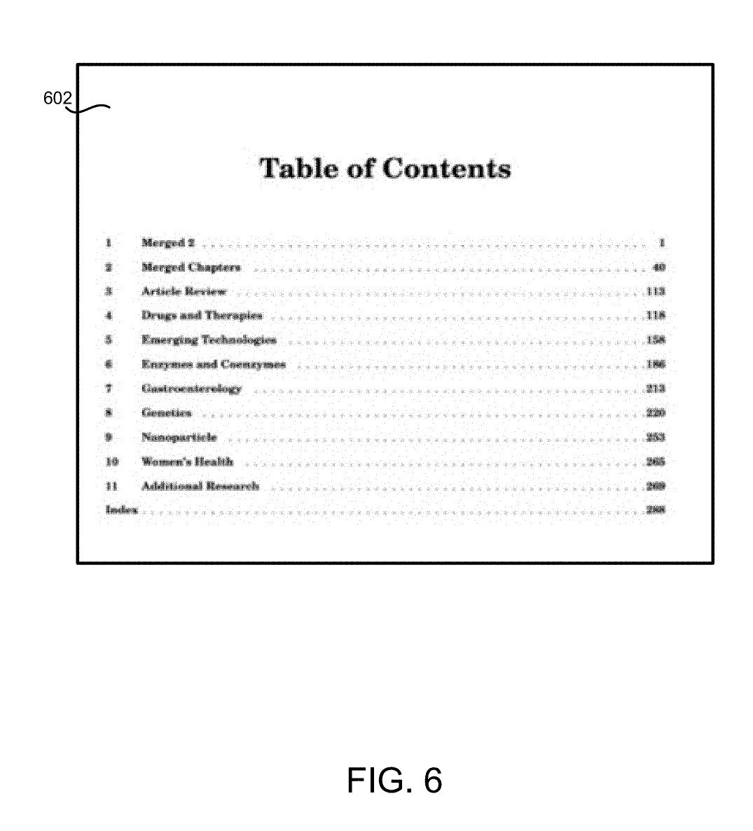

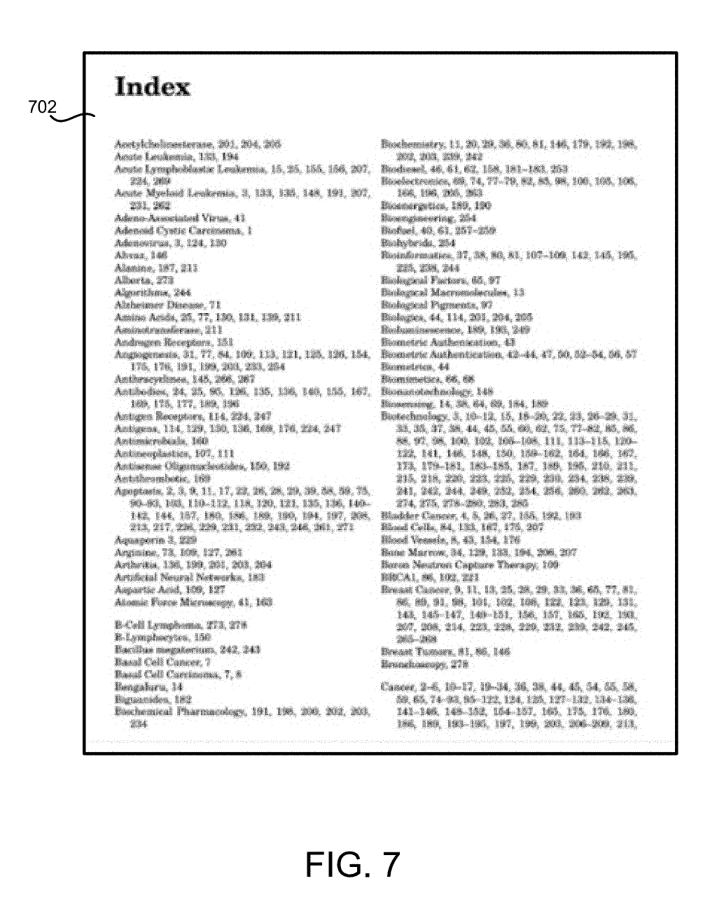

As part of the newsletter generation process, a table of contents may be generated, illustrated in FIG. 6 as a table of contents 602. The table of contents 602 can be the chapters 404. Also as part of the newsletter generation process, an index, such as an index illustrated in FIG. 7, can be generated. The index 702 can include the filters and the pages in the newsletter at which the filters can be found.

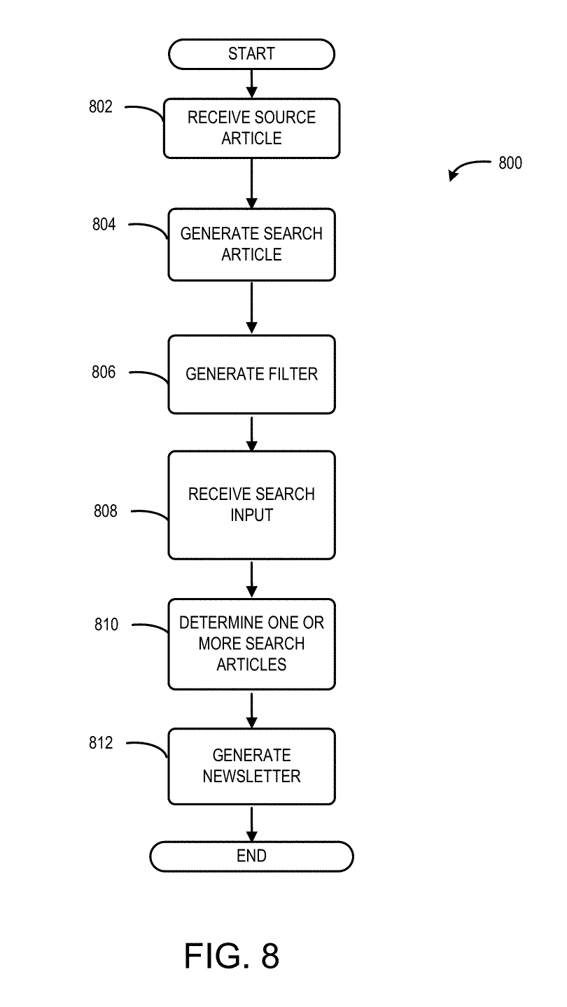

FIG. 8 is a flow diagram showing aspects of a method 800 disclosed herein for generating a newsletter. It should be understood that the operations of the method 800 are not necessarily presented in any particular order and that performance of some or all of the operations in an alternative order(s) is possible and is contemplated. The operations have been presented in the demonstrated order for ease of description and illustration. Operations can be added, omitted, and/or performed simultaneously, without departing from the scope of the appended claims.

It also should be understood that the illustrated method 800 can be ended at any time and need not be performed in its entirety. Some or all operations of the method 800, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Computer-storage media does not include transitory media.

Thus, it should be appreciated that the logical operations described herein can be implemented as a sequence of computer implemented acts or program modules running on a computing system, and/or as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules can be implemented in software, in firmware, in special purpose digital logic, and any combination thereof.

For purposes of illustrating and describing the technologies of the present disclosure, the method 800 disclosed herein is described as being performed by the source server 102 and user devices 104 via execution of computer executable instructions such as, for example, the newsletter generator 108. As explained above, the newsletter generator 108 can include functionality for generating newsletters.

While the method 800 is described as being provided by the source server 102, it should be understood that the source server 102 can provide the functionality described herein via execution of various application program modules and/or elements. Additionally, devices other than, or in addition to, the source server 102 can be configured to provide the functionality described herein via execution of computer executable instructions other than, or in addition to, the newsletter generator 108. As such, it should be understood that the described configuration is illustrative, and should not be construed as being limiting in any way.

The method 800 begins at operation 802, where a source article 112 is received. The source article 112 can be one or more documents, web pages, and the like containing information generated by a source.

The method 800 continues to operation 804, where a search article 116 is generated. In some examples, the search article 116 is generated using information from the source article 112 but generated in a manner that is suitable for search and newsletter generation.

The method 800 continues to operation 806, where a filter is generated. In some examples, a filter is a keyword or phrase that is generated when the search article 116 is generated.

The method 800 continues to operation 808, where a search input is received. The search input can be one or more terms or phrases used to search for one or more of the search articles 116.

The method 800 continues to operation 810, where one or more of the search articles 116 are determined based on the search. The method 800 continues at operation 812, where a newsletter is generated. The method 800 thereafter ends.

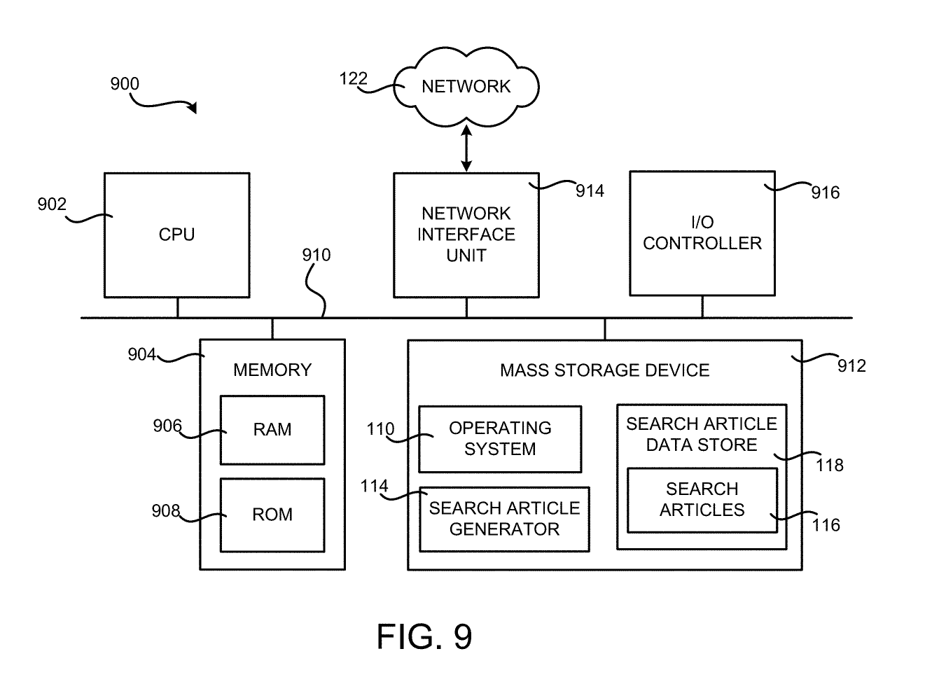

FIG. 9 illustrates an illustrative computer architecture 900 for generating a newsletter. Thus, the computer architecture 900 illustrated in FIG. 9 illustrates an architecture for a server computer, mobile phone, a smart phone, a desktop computer, a netbook computer, a tablet computer, and/or a laptop computer. The computer architecture 900 can be utilized to execute any aspects of the software components presented herein.

The computer architecture 900 illustrated in FIG. 9 includes a central processing unit 902 (“CPU”), a system memory 904, including a random access memory 906 (“RAM”) and a read-only memory (“ROM”) 908, and a system bus 910 that couples the memory 904 to the CPU 902. A basic input/output system containing the basic routines that help to transfer information between elements within the computer architecture 900, such as during startup, is stored in the ROM 908. The computer architecture 900 further includes a mass storage device 912 for storing the operating system 110 and one or more application programs or data stores including, but not limited to, the search article generator 114, the search article data store 118, and the search articles 116.

The mass storage device 912 is connected to the CPU 902 through a mass storage controller (not shown) connected to the bus 910. The mass storage device 912 and its associated computer-readable media provide non-volatile storage for the computer architecture 900. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 900.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media can include volatile and non-volatile, removable and non-removable media implemented in any method or technology for storage of information such as computer-readable instructions, data structures, program modules or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 900. For purposes the claims, a “computer storage medium” or “computer-readable storage medium,” and variations thereof, do not include waves, signals, and/or other transitory and/or intangible communication media, per se. For the purposes of the claims, “computer-readable storage medium,” and variations thereof, refers to one or more types of articles of manufacture.

According to various configurations, the computer architecture 900 can operate in a networked environment using logical connections to remote computers through a network such as the network 122. The computer architecture 900 can connect to the network 122 through a network interface unit 914 connected to the bus 910. It should be appreciated that the network interface unit 914 can also be utilized to connect to other types of networks and remote computer systems. The computer architecture 900 can also include an input/output controller 916 for receiving and processing input from a number of other devices, including a keyboard, mouse, or electronic stylus (not shown in FIG. 9). Similarly, the input/output controller 916 can provide output to a display screen, a printer, or other type of output device (also not shown in FIG. 9).

It should be appreciated that the software components described herein can, when loaded into the CPU 902 and executed, transform the CPU 902 and the overall computer architecture 900 from a general-purpose computing system into a special-purpose computing system customized to facilitate the functionality presented herein. The CPU 902 can be constructed from any number of transistors or other discrete circuit elements, which can individually or collectively assume any number of states. More specifically, the CPU 902 can operate as a finite-state machine, in response to executable instructions contained within the software modules disclosed herein. These computer-executable instructions can transform the CPU 902 by specifying how the CPU 902 transitions between states, thereby transforming the transistors or other discrete hardware elements constituting the CPU 902.

Encoding the software modules presented herein can also transform the physical structure of the computer-readable media presented herein. The specific transformation of physical structure can depend on various factors, in different implementations of this description. Examples of such factors can include, but are not limited to, the technology used to implement the computer-readable media, whether the computer-readable media is characterized as primary or secondary storage, and the like. For example, if the computer-readable media is implemented as semiconductor-based memory, the software disclosed herein can be encoded on the computer-readable media by transforming the physical state of the semiconductor memory. For example, the software can transform the state of transistors, capacitors, or other discrete circuit elements constituting the semiconductor memory. The software also can transform the physical state of such components in order to store data thereupon.

As another example, the computer-readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 900 in order to store and execute the software components presented herein. It also should be appreciated that the computer architecture 900 can include other types of computing devices, including hand-held computers, embedded computer systems, personal digital assistants, and other types of computing devices known to those skilled in the art. It is also contemplated that the computer architecture 900 might not include all of the components shown in FIG. 9, can include other components that are not explicitly shown in FIG. 9, or might utilize an architecture completely different than that shown in FIG. 9.

Based on the foregoing, it should be appreciated that technologies for generating a newsletter have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes can be made to the subject matter described herein without following the example configurations and applications illustrated and described, and without departing from the true spirit and scope of the present invention, aspects of which are set forth in the following claims.

What is claimed is:

1. A computer-implemented method, the method comprising:
receiving a source article;
generating a search article and a plurality of filters associated with the source article;
receiving a search input;
determining a plurality of search articles using the search input; and
generating a newsletter comprising the plurality of search articles.

2. The computer-implemented method of claim 1, the search article is generated using an artificial intelligence journalist.

3. The computer-implemented method of claim 1, wherein generating the search article and the at least one filter associated with the source article comprises applying at least a second filter to eliminate a predetermined type of information to generate filtered information.

4. The computer-implemented method of claim 3, wherein the predetermined type of information comprises non-factual information, an opinion, colloquial information, or relativistic information.

5. The computer-implemented method of claim 3, further comprising adding information to the filtered information to connect at least one concept found in the filtered information to generate enhanced information to be used as the search article.

6. The computer-implemented method of claim 1, wherein generating the newsletter comprising the plurality of search articles comprises generating a plurality of chapters.

7. The computer-implemented method of claim 6, wherein generating the plurality of chapters is based on the plurality of filters.

8. The computer-implemented method of claim 7, further comprising determine the plurality of chapters based on a predetermine number of occurrences of one filter of the plurality of filters among the plurality of search articles.

9. The computer-implemented method of claim 1, wherein generating the newsletter comprising the plurality of search articles comprises generating a table of contents.

10. The computer-implemented method of claim 1, wherein generating the newsletter comprising the plurality of search articles comprises generating an index comprising the plurality of filters and pages in the newsletter at which the plurality of filters can be found.

11. A computer-readable storage medium having computer-executable instructions stored thereupon that, when executed by a computer, cause the computer to:
receive a source article;
generate a search article and a plurality of filters associated with the source article;
receive a search input;
determine a plurality of search articles using the search input; and
generate a newsletter comprising the plurality of search articles.

12. The computer-readable storage medium of claim 1, the search article is generated using an artificial intelligence journalist.

13. The computer-readable storage medium of claim 1, wherein the computer-executable instructions to generating the search article and the at least one filter associated with the source article comprises computer-executable instructions to apply at least a second filter to eliminate a predetermined type of information to generate filtered information.

14. The computer-readable storage medium of claim 3, wherein the predetermined type of information comprises non-factual information, an opinion, colloquial information, or relativistic information.

15. The computer-readable storage medium of claim 3, further comprising computer-executable instructions to add information to the filtered information to connect at least one concept found in the filtered information to generate enhanced information to be used as the search article.

16. The computer-readable storage medium of claim 1, wherein the computer-executable instructions to generate the newsletter further comprises computer-executable instructions to generate a plurality of chapters.

17. The computer-readable storage medium of claim 6, wherein the computer-executable instructions to generating the plurality of chapters uses the plurality of filters.

18. The computer-readable storage medium of claim 7, further comprising computer-executable instructions to determine the plurality of chapters based on a predetermine number of occurrences of one filter of the plurality of filters among the plurality of search articles.

19. The computer-readable storage medium of claim 1, wherein the computer-executable instructions to generating the newsletter comprising the plurality of search articles further comprises computer-executable instructions to generate a table of contents and an index comprising the plurality of filters and pages in the newsletter at which the plurality of filters can be found.

20. A system comprising:
a processor; and
a computer-readable storage medium in communication with the processor, the computer-readable storage medium having computer-executable instructions stored thereupon which, when executed by the processor, cause the processor to:
receive a source article;
generate a search article and a plurality of filters associated with the source article;
receive a search input;
determine a plurality of search articles using the search input; and
generate a newsletter comprising the plurality of search articles.
